(19) United States
(12) Patent Application Publication
(10) Pub. No.: US 2004/0157086 A1
(43) Pub. Date: Aug. 12, 2004

(54) Disk-type magnetic storing device and a method for manufacturing the same

(76) Inventors: Chung-Nam Hwang, Seoul (KR); Gap-Soo Chang, Daegu (KR)

Correspondence Address: MCGUIREWOODS, LLP, 1750 TYSONS BLVD, SUITE 1800, MCLEAN, VA, 22102, US

(21) Appl. No.: 10/468,739

(22) PCT Filed: Jan. 8, 2002
(86) PCT No.: PCT/KR02/00029

(30) Foreign Application Priority Data
Feb. 23, 2001 (KR) 2001-0009329

(51) Int. Cl. B32B 9/00

(52) U.S. Cl. 428/693

(57) ABSTRACT

This invention relates to a disk-type magnetic storing device and a method for manufacturing the same. This invention presents an ion beam treatment by which the magnetic momentum is enhanced and the coercivity can be changed and an easy-axis is set in some area of the magnetic layer. This invention also presents the magnetic storage of which magnetic layer has easy-axis by using ion beam treatment. Therefore, the physical limitation of the conventional magnetic layer is overcome. According to this invention, the recording density can be expanded extremely.

### TECHNICAL FIELD

The present invention is related to a magnetic storage device, which has the ultra-high density storage capacity. In particular, the present invention is related to a manufacturing method of the ultra-high density magnetic storage device which includes a media in which an easy axis is formed at a bit cell which is the minimum unit for storing information, and the magnetic storage device by the same method.

### BACKGROUND OF THE ART

During the last few decades, the technologies related to treating of information have been improved drastically. People will need more and more information not only in this era, which is so called the information era but also in the future. Therefore, people will use and need storage devices like back-up tape, hard disk or removable storage devices in order to keep, maintain and store their information. Especially, in order to store large amount of information, which increases steadily, request and need for storage device, which has ultra-high storage density also increases and accordingly the market related to the ultra-high density storage device increases.

The representative methods of storing information are using the magnetic media like the magnetic tape, the magnetic disk, and the magnetic drum. A system using the disk type magnetic storage media is the most widely used method among them. A floppy disk driver system (FDD), a hard disk driver system (HDD) and a magneto-optical disk driver system (MOD) are the methods using the disk type magnetic storage media. Among the high-density magnetic storage device, the hard disk driver system has been in the center of development. The hard disk uses, so called ‘the longitudinal recording method’ in which the information is stored by applying the magnetic field parallel to the surface of the substrate when the magnetic thin film is coated on the disk type substrate. The structure of the disk type magnetic storage device, which is the representative of the hard disk, is explained with reference to FIG. 1a, hereinafter. The magnetic disk 1 in which a magnetic thin film is coated on the disk type substrate is assembled to rotate around the rotation axis 7. A magnetic head 3 for recording and retrieving data on the surface of the magnetic disk 1 is installed. The magnetic head 3 is installed at the end of a head arm 5, which is connected to the driving part 9 that is installed at one end of the magnetic disk 1. The magnetic disk 1 includes a data zone 21 in which the information is recorded and a parking zone 23 in which the head 3 is kept when it is not operating. The magnetic head 3 can record or retrieve data on the data zone 21 by controlling the driving part 9.

The structure of the magnetic disk, which is one of the main components of the hard disk system is explained referring to FIG. 1b which is the cross-sectional view of FIG. 1a cut along the line A-A′. An under-layer 13 is formed by depositing a metal which includes Cr, CrV, or CrTa with a thickness of about 500 Å on the substrate 11 which is formed by Al/Mg or glass. A magnetic thin layer 15 is formed by depositing ferromagnetic material like CoCrPt, CoCrPtB, CoPtCrTa, FePtCr or CoNiCr with a thickness of about 200 Å^{˜}300 Å on the under-layer 13. A protection layer 17 is formed by depositing C:Nx about 100 Å on the magnetic thin layer 15 and a lubrication layer 19 is formed consequently by depositing lubricating material with a thickness of about 20 Å on the protection layer 17.

Storing information on the magnetic disk is done by forming a bit cell which is the minimum unit determined by the magnetic head. In general, a bit cell has a rectangular shape. The shorter side of the bit cell is parallel to the rotation direction of the magnetic disk and the longer side of the bit cell is parallel to with of the track. In general, the longer side of a bit cell is the width (same with the width of the track) and the shorter side of the bit cell is the length. FIG. 2 shows the structure of how bit cell is composed by the operation of the magnetic head on the magnetic media (magnetic disk). A magnetic head 3 has the structure in which a retrieving head 31 and a recording head 33 are assembled nearby. The retrieving head 31 is composed of magnetic sensor, which detects the magnetic resistance. The recording head 33 is an electromagnet, which is made by winding copper coil 35 at a permalloy core and is a kind of a device producing magnetic field. Recording information on the magnetic disk 1 is done as the magnetic field occurs between the poles gap (G) of the recording head 33 as the electric signal is applied to the coil 35 of the recording head 33. A bit cell 25 is formed at the area corresponding the magnetic field at the surface of the magnetic disk 1 which moves under the recording head 33. The bit cell 25 has a rectangular shape and the length of the bit (L_{b}) is determined by the relationship among the amount of the pole interval (G) of the recording head 33, the moving speed of the magnetic disk 1 and the electric signal applied to the and coil 35. The width of bit cell (W_{b}) is determined by the width (Wₕ) of the recording head 33. The width of bit (W_{b}) is identical to the width of track. In the conventional longitudinal recording, the size of the disk was enlarged, numbers of disks were increased or recording density was increased in order to increase the storage of data. The most effective method of these methods is to increase the recording density, in other words, increase the number of bit cell per unit area. By using this method not only the storage capacity is increased but also the data transfer rate is faster than other methods. Therefore, many disk manufacturers are investigating much money and manpower to develop a new technology in increasing the storage density. In order to increase the storage density, the size of the magnetic head should designed to be smaller. FIG. 3 shows how the size of a bit cell changes according to the increase of the storage density. Numbers in the parenthesis shows the width length ratio (W/L ratio) of a bit cell. For example, hard disk manufacturers are producing products in which 20-40 Gbit/in² techniques are applied and in their laboratories technologies to achieve 40-100 Gbit/in² are under development.

Reducing the size of the head is a difficult technology according to the contemporary technology.

There are several reasons why the head size cannot be reduced easily. First, the increasing the data rate in proportion to linear density may be beyond our electronics capability, though we do increase it as fast as technology permits. Second, the RPM (revolution per minute) also has to increase for the high technology products. This makes the data rate problem worse. Third, an inductive read back signal decreases with scaling, and electronics noise increases with bandwidth, so that the signal-to-noise (S/N) ratio decreases rapidly with scaling if inductive heads are to be used for reading. For magneto-resistive (MR) heads, the scaling laws are more complex, but tend to favor MR increasingly over inductive heads as size is decreased. Fourth, The fourth reason is that the construction of thin-film heads is limited by lithography and by the mechanical limits. Therefore we do not choose to scale all dimensions at the same rate. this has led to the design of heads which are much larger in some dimensions than simple scaling would have produced. This violation of scaling has produced heat-dissipation problems in the heads and in the electronics, as well as impaired write head efficiencies. Fifth, the distances between components have not decreased as rapidly as the data rates have increased, leading to problems with electrical transmission-line effects. The last reason, which will ultimately cause very fundamental problems, is that the materials are not unchanged under the scaling process; we are reaching physical dimensions and switching times in the head and media at which electrical and magnetic properties are different than they were at lower speeds and at macroscopic sizes. We are also approaching a regime in which the spacing between head and disk becomes small enough that air bearings and lubrication substantially from their present behavior, and where surface roughness cannot be scaled smaller because it is approaching atomic dimensions. (Reference “The Future Of Magnetic Data Storage Technology” IBM J. Res. Develop. Vol. 44 No. 3 May 2000 by D. A. Thompson J. S. Best).

The problems that might occur at the point of increasing the storage density have been looked at to this point. According to the analysis on the basis of the researches, the problem of increasing the recording density occurs due to the physical limits of magnetic disk before facing the problems of reducing the size of the head. The problems of the magnetic disk in increasing the recording density will be explained hereinafter. A magnetic thin film which is made of ferro-magnetic material and which is the main part of the magnetic disk comprises poly-crystal material. The poly-crystal magnetic thin film comprises small single crystal called ‘grain’. If a bit cell can have the ability of storing data, it has to include at least 500 grains. If the size of bit cell is reduced, in order to increase the storage density of the magnetic disk, the size of the grain also has to be decreased so that at least 500 grains are included in the bit cell. In order to achieve ultra-high density storage a magnetic thin film including smaller size grains has to be included. However, if the grain gets smaller to the size of about 8 nm, they loose strength among the neighboring grains and the magnetic energy would be less than the thermal stability energy and as a result the magnetic energy is lost, the data is lost. This phenomenon is called ‘Super-paramagnetic limits’ which exists when increasing the recording density. The limit of the storage density according to the super-paramagnetic limits is calculated as about 40 Gbit/in² at the conventional longitudinal recording method. Besides, the grains are gathered to comprise a bit, the shape of bit is not clear rectangular shape so that the boundary is also not clearly defined. When the bit size is big the ambiguous boundary does not have any influence but if the bit size gets smaller, the ambiguous boundary becomes the reason for noise when retrieving the data.

Also, when the recording density is increased, the small bits are designed to be close to one another. In such a case, recorded data changes due to the exchange coupling between bit cell and electromagnetic exchange force which influence bit cells.

Technologies for ultra-high storage density have been developed and published in order to overcome the problems of the conventional storage media. In the early 2001, the super-paramagnetic limit can be extended to 100 Gibt/in² by using Anti Ferromagnetic Coupling (AFC) according to the announcement of IBM. In the AFC technology, the conventional magnetic thin film is divided into a first magnetic thin film and a second magnetic thin film. 3 atomic layer of Ruthenium, which is a rare earth material, is inserted between the first and second magnetic thin film. In this case, even if the size of grain is reduced to 4nm on the second magnetic thin film, which is formed on top, the super-paramagnetic limits do not occur so that ultra-high storage device is achieved.

The perpendicular recording system and the patterned media system are other ways of achieving ultra-high storage device. In perpendicular recording system, a bit cell, which has the magnetic axis perpendicular to the surface of the magnetic disk, is formed. This method can increase the storage density 2 to 4 times compared to the longitudinal method however; it is not popular among manufacturers. The reason is because the technologies to customize the perpendicular method are not developed. The recording head used in the longitudinal method is not applicable to the perpendicular method so a recording head, which has single pole, is required. However, this single head has difficulties for customizing and there are some problems in re-recording and removing the re-recorded data. For the perpendicular method, the magnetic thin film has to be thicker than that of the longitudinal method for more than 10,000 times. If the magnetic thin film gets thicker, the size of grains get bigger so it is very difficult to make the magnetic thin film thick in order to achieve high density storage.

The patterned media has been introduced by the U.S. Pat. Nos. 5,956,216 and 6,146,755, which are deigned by IBM. In this method, a domain (or grain) which is the basic unit having magnetic characteristic is composed as one bit. Each of bits is arranged on the non-magnetic substrate with a certain distance. The patterned media comprises of single bit as a single domain is a method, which can achieve the maximum limit in which the recording density can be extended. In theory, the super-paramagnetic limit does not occur, as the bits are thermally stable even if the size of the bit is reduced to 1/n compared to the longitudinal method in which one bit is n number of grains. The magnetic thin film according to this method is thermally stable and the signal to noise ration is very good in the ultra-high density status. If this method is used at least 400 Gibts/in² recording density can be achieved and as the nano-technology develops terra bits/in² recording density is achievable. The reason for this patterned media not being popular in the market is because manufacturing cost is too high.

### DISCLOSURE OF INVENTION

The object of the present invention is to provide a storage device with ultra-high recording density. Another object of the invention is to provide a magnetic storage device with ultra-high density overcoming the limits of longitudinal method, while using the longitudinal method. Yet anther object of the invention is to provide a manufacturing method of storage device in which a magnetic easy axis is formed per basic unit of recording for the magnetic storage device having ultra-high density storage capacity. Still another object of the invention is to provide a manufacturing method of a storage media in which exchange coupling and electromagnetic exchange force at the neighboring bit cells are minimized or eliminated for the ultra-high density storage capability.

The present invention first presents a magnetic media in which an easy axis is formed according to selected one direction between an angular direction and a radius direction in the polar coordinate system of the disk type magnetic media. Second, the present invention presents a magnetic media in which there are two easy axis of different direction in the neighboring areas, so the exchange coupling and electromagnetic exchange force are minimized or eliminated. Third, the present invention presents a magnetic storing device including a magnetic media which has easy axis that is formed in parallel to at least one axis of coordinate system which determines the operation method of the magnetic storing device and a magnetic head which can record and retrieve data on the magnetic media.

The method for manufacturing a magnetic media according to present invention comprises steps of forming a ferro-magnetic thin film by depositing materials like Co, Ni or Fe on the substrate and treating the magnetic thin film using an ion beam including inertia gas such as He, Ne, Ar, Xe, Kr or N₂⁺ O₂⁺ in order to form a magnetic easy axis on the magnetic thin film or control magnetic characteristic of magnetic thin film. The energy of the ion beam is preferable to variable between 40 KeV and 120 KeV. Furthermore, it preferable that an external magnetic filed with the magnetic field of 500 gauss to 5,000 gauss is supplied on the magnetic thin film in parallel of perpendicular to the surface.

One magnetic storing device according to the present invention comprises a magnetic media including bit cell, which has at least one magnetic easy axis. Another magnetic storing device according to the present invention comprises a magnetic media including two bit cell groups in which each group has the individual easy axis having the different direction. The magnetic media of the storing device according to the present invention includes a magnetic thin film of which structure is in meta-stable state distinguished with the natural stable state by treating the magnetic thin film using ion beam. The meta-stable state is that the volume of the atom lattice structure of the magnetic material is lager 3% than the stable state. This meta-stable state can get from annealing with 10^{3˜}10⁴ Kelvin degrees within instance time of 10^{-13˜}10⁻¹¹ seconds by bombarding of the ion beam and quenching within very instance time less than 10⁻¹¹ seconds. Then, the magnetic momentum is enlarged up to 35%^{˜}55%. Furthermore, the electrons of the 3d orbit, which determines the ferromagnetic material or not, are localized by supplying an external magnetic field during annealing using ion beam. Therefore, the magnetic momentum and the coercivity, the properties of the magnetic material can be increased and set an easy axis along to the wanted direction. The inventor of this patent application introduces these contents in ‘Physical Review Letters Volume 87, Number 6 which is published in Aug. 6th, 2001’.

### BRIEF DESCRIPTION OF DRAWINGS

FIG. 1a is a plane view showing the general structure of the hard disk system represented the magnetic storing devices.

FIG. 1b. is a cross-sectional view showing the general structure of the magnetic media (magnetic disk) used in the hard disk system.

FIG. 2 is perspective view showing the operational structure of the storing media and head of the conventional hard disk system.

FIG. 3 shows the changes of the bit cell size according to the recording density.

FIGS. 4a and 4b show one method for manufacturing the magnetic disk having magnetic easy axis using stencil mask according to the present invention.

FIGS. 5a, 5b, 6a and 6b show another method for manufacturing the magnetic disk having easy axes of which the directions on the neighboring tracks are set in different directions according to the present invention.

FIG. 7 shows one example of stencil mask and the usage of the stencil mask for manufacturing the magnetic disk having easy axes of which the directions on the neighboring tracks are set in different directions according to this invention.

FIG. 8 shows one magnetic storing device including a magnetic disk having easy axes of which the directions on the neighboring tracks are set in different directions and magnetic head set which can be designed for recording or retrieving data on the magnetic media according to the present invention.

FIGS. 9a, 9b, 10a and 10b show yet another method for manufacturing the magnetic disk having easy axes of which the directions on the neighboring bit cells are set in different directions.

FIG. 11 shows bit array state of the patterned media according to the conventional method.

FIG. 12 shows bit array state of the magnetic media having easy axes of which the directions on the neighboring bit cells are set in different directions according to the present invention.

FIG. 13 shows another magnetic storing device including a magnetic disk having easy axes of which the directions on the neighboring bit cells are set in different directions and magnetic head set which can be designed for recording or retrieving data on the magnetic disk according to the present invention.

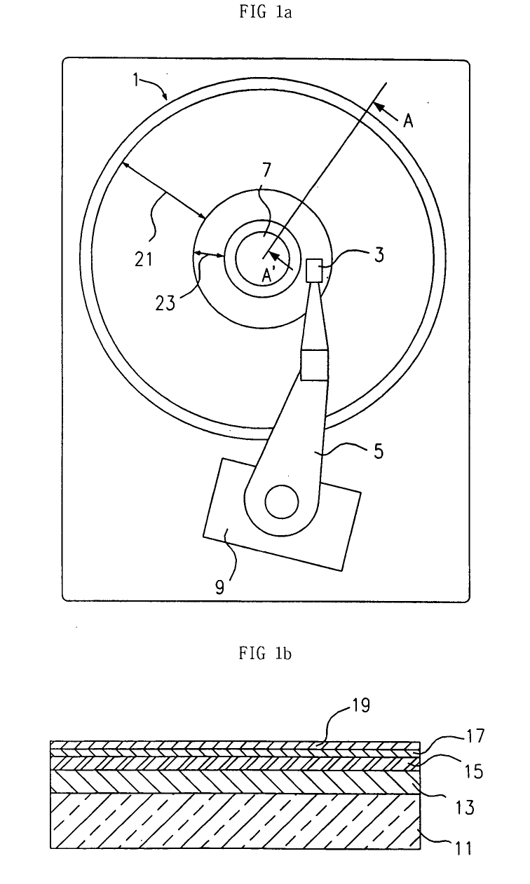

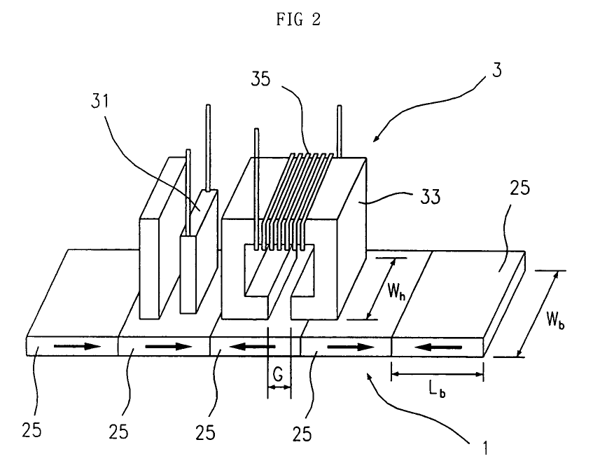

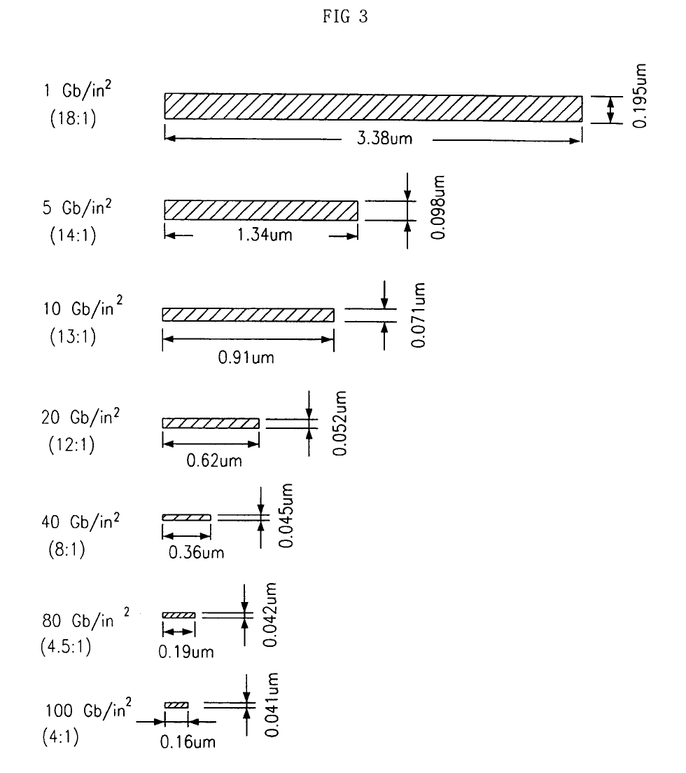

### BEST MODE FOR CARRYING OUT THE INVENTION

### PREFERRED EMBODIMENT 1

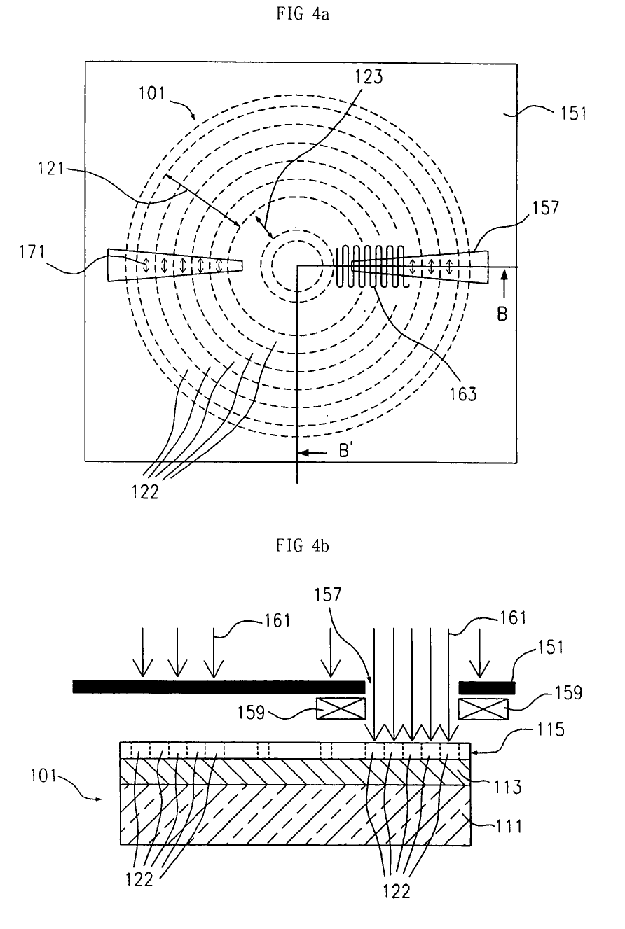

In this preferred embodiment, we will explain the magnetic media including bit cells having easy axis of which direction formed along to the angular direction of the polar coordinate system. The FIG. 4a is a plane view showing the method for manufacturing the disk type magnetic media having magnetic easy axis according to the present invention. The FIG. 4b is a cross-sectional view cutting along to the line B-B′ of the FIG. 4a.

Prepare a substrate 111 of disk shape and including glass or Al/Mg. By depositing a material including Cr on the substrate 111, form a under layer 113. By depositing a ferro-magnetic material such as CoPt, CoPtCr, CoPtCrTa, FePt or FePtCr, form a magnetic layer 115. Therefore, a magnetic disk 101 can be manufactured. The magnetic layer 115 comprises a data zone 121 in which digitized data can be stored, and a parking zone 123 in which the head is kept when it is not operating. In the data zone 121 a series of tracks 122 are arrayed with the same center point, and on each tracks 122, a series of data bits (not showing in figures) are arrayed linearly.

Set the magnetic disk 101 in a vacuum chamber of 10⁻⁷ vacuum degrees. The magnetic disk 101 can be rotate to the center point of the disk. As shown in FIG. 4a, prepare a stencil mask 151. It is preferable that the size of the stencil mask 151 is bigger than that of the magnetic disk 101. The stencil mask 151 has slit type aperture 157 which open some part of the magnetic disk 101 through it. It is preferable that the aperture 157 has longer side of which size is bigger than the radius of the magnetic disk 101 and shorter side of which size is similar to the bit length. It is possible that the size of the shorter side is accordance with the sum of tens or hundreds of bit cell length for the manufacturing needs. The reason is that the sum of tens or hundreds of bit can be treated, as one unit line not arc part in macroscopic view part in macroscopic view. It is preferable that the aperture 157 is set along to the direction of zero degree from the center of magnetic disk 101 in the polar coordinate system. Furthermore, it is preferable that additional aperture can be formed along to the direction of 180 degree from the center of magnetic disk 101 for the efficiency of production yields.

With holding the stencil mask 151, rotate the magnetic disk 101 with constant velocity. According to the user's needs, one method can be selected between constant angular velocity and constant linear velocity. At the same time of rotation, an ion beam 161 including Ar⁺ is implanted into the magnetic disk 101 through the aperture 157. The ion source for the ion beam can be selected one of inertia gas such He, Ne, Xe or Kr, or one of N₂⁺ and O₂⁺ gases. At this time, it is preferable that the ion beam 161 has a scanning path 163 as shown in FIG. 4a for setting the direction of the easy axis along to the angular (rotation) direction. To do so, the reciprocal frequency of the Y-axis in the rectangular coordinate system is set faster and the reciprocal frequency of the X-axis is set slower than Y-axis, so that the pattern of the scanning path would be a Lissajous figures. For example, the frequency of the Y-axis is set to hundreds Hz^{˜} several KHz and the frequency of the X-axis is set to tens Hz. Then, the direction of the magnetic easy axis 171 is parallel to the direction of the length of the bit cell (angular direction), the faster frequency axis of the scanning path 163. If one wants to set the direction of the easy axis 171 to the radius direction (direction of the width of the bit cell), it is preferable to set the frequency vice versa. By rotating the magnetic disk 101, the ion beam is implanted into the magnetic layer equivalently and the easy axis 171 is formed along to the arc of the disk. According to the rotation of the magnetic disk 101, the main axis of the scanning path can be influenced by the rotation. In this case, it is preferable to find the optimized rotation speed of the disk for the wanted direction of the easy axis through the experiences and the computer simulations.

For the effective method for setting the easy axis on the wanted direction, set a magnet 159 around the aperture 157 in order to supply an external magnetic field on the magnetic layer 115 when is treated by the ion beam 161. At this time, it is preferable that the direction of the magnetic field is set to the direction of the easy axis 171. To do this is to use the phenomenon in which the easy axis 171 can be set along to the direction of the applied magnetic field when the magnetic layer 115 is annealed. In another method, as the stencil mask 151 is formed with a magnetic material and applied a magnetic field, then an induced magnetic field is formed between the aperture 157. In this case, there is no additional magnet 159 to apply an external magnetic field.

Generally, the magnetic bit cell is designed with rectangular shape. There are many reasons to do so. The main reason is that the magnetized direction can be maintained using the shape anisotropy energy of the bit cell. According to the present invention, when an easy-axis is set, then it is possible to maintain the magnetized direction with isotropic shape of the bit cell such as circle or quadrangle. Therefore, as apply the concept of the present invention to the conventional technique of the magnetic media with recording density of 20 Gbits/in², then the recording density can be increased up to 12 times by designing the shape of bit cell from rectangular with W/L ratio of 12:1 to quadrangle with W/L ratio of 1:1. In other words, if the W/L ratio were reduced to 6:1, then the recording density would be 40 Gbits/in². If the W/L ratio were reduced to 3:1, then the recording density would be 80 Gbits/in². In scaling down the head size, it is possible to get ultra-high density over 200 Gbits/in² by reducing the length of the head size with the same size of the gap (G) of the head until being the W/L ratio up to 1:1. This method more effective and easier than conventional scaling down method of head size in which the longer and shorter sides of the head are reduced simultaneously.

The magnetic storing device comprises a magnetic media and a magnetic head recording or retrieving data on the magnetic media. The magnetic media according to this preferred embodiment has an easy axis, which is not comprised in conventional magnetic media. The arraying method is similar to arraying method of the bit cell in the conventional magnetic media. Therefore, the head for magnetic media according to this preferred embodiment is the same of the conventional magnetic storing device. Hence, the magnetic storing device adapting the magnetic media of this preferred embodiment has the advantages of ultra-high recording density with conventional structure.

### PREFERRED EMBODIMENT 2

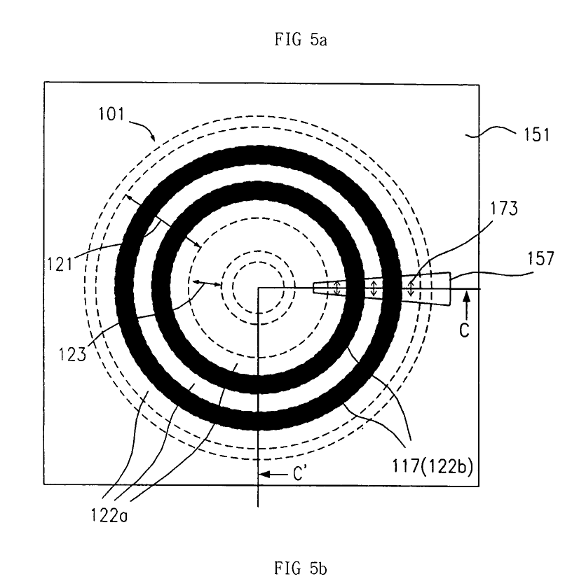

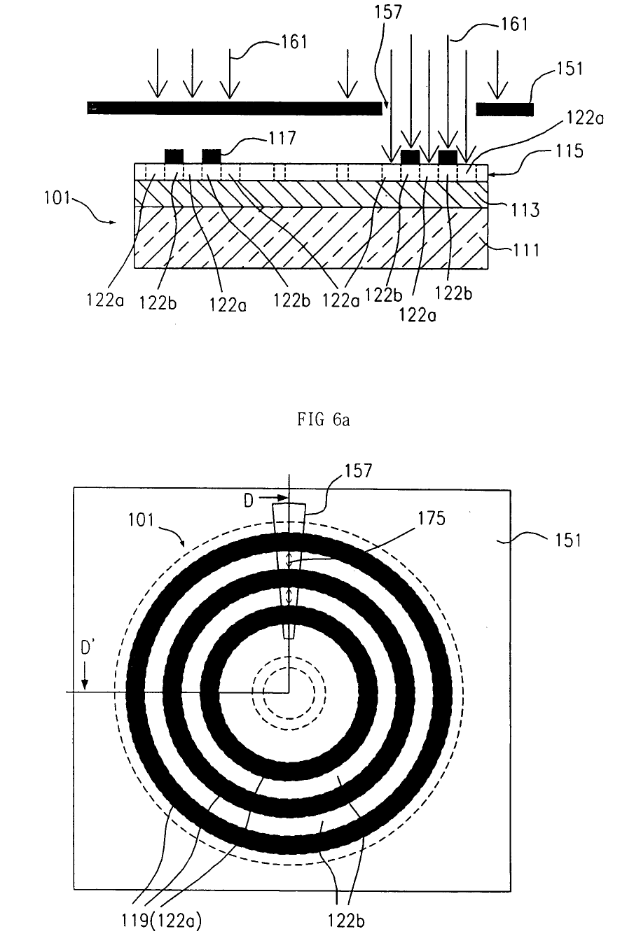

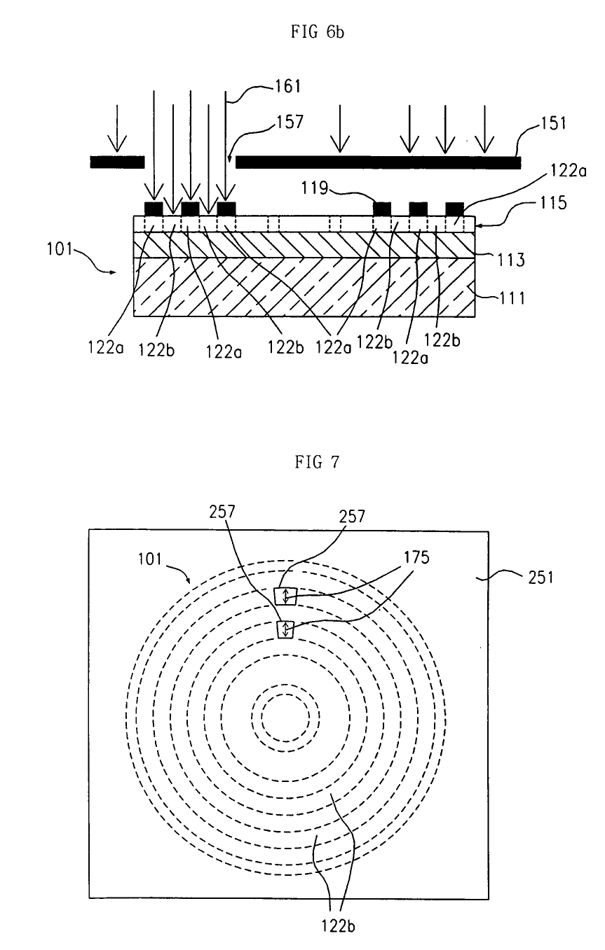

As increasing the recording density accordance with the preferred embodiment 1, the higher recording density occurs the increasing number of tracks. Therefore, the number of track gaps for distinguishing the tracks is also increased. The track gap is not for storing information, but for distinguishing the neighboring tracks. This embodiment presents a method for using the track gap as another new storing area for information. This embodiment explains the representative method for manufacturing a magnetic media including two kinds of tracks in each track having different easy axis. The FIG. 5a and 6a are the plane views showing the method for forming two kinds of track group having different easy axis. The FIG. 5b and 6b are the cross sectional views cutting along to the line C-C′ and D-D′, respectively.

As shown in FIG. 5a and 5b, prepare a substrate ill of disk shape including glass or Al/Mg. By depositing a material including Cr on the substrate 111, form a under layer 113. By depositing a ferro-magnetic material such as CoPt, CoPtCr, CoPtCrTa, FePt or FePtCr, form a magnetic layer 115. Therefore, a magnetic disk 101 can be manufactured. The magnetic layer 115 comprises a data zone 121 in which digitized data can be stored, and a parking zone 123 in which the head is kept when it is not operating. In the data zone 121 a series of tracks are designed in which divided in to odd numbered track 122a and even numbered track 122b. On each tracks, a series of data bits having certain length are arrayed linearly. Using spin coating method, a photo-resist is deposited on the magnetic layer 115.

By patterning the photo-resist, the odd numbered tracks 122a are opened, and the even numbered tracks 122b are covered by the remained photo-resist 117. Prepare a stencil mask 151 larger than magnetic disk 101. The stencil mask 151 has silt shaped aperture 157. The aperture 157 has a width similar to the bit length and a length similar to the radius of the magnetic disk 101.

The magnetic disk 101 is set in the vacuum chamber in the capable of rotation to the center of disk. The stencil mask 151 is set on the magnetic disk 101. At this case, it is preferable that the aperture 157 is aligned to the direction of zero degree from the center of the magnetic disk 101 or the direction of 180 degree from the center. Rotate the magnetic disk 101 in constant velocity. An ion beam 161 including Ar⁺ is injected into the magnetic disk 101 through the aperture 157, so that the Ar⁺ ions are implanted into the magnetic layer 115. After that, a first easy axis 173 of which direction is accordance to the angular direction of the polar coordinate is formed on the odd numbered tracks 122a. On the other hands, there is no influence on the even numbered tracks 122b covered by the photo-resist 117.

As shown in FIG. 6a and 6b, remove the photo-resist 117 and re-deposit new photo-resist on the magnetic layer 115. By patterning the photo-resist, the even numbered tracks 122b are opened, and the odd numbered tracks 122a are covered by the remained new photo-resist 119. The stencil mask 151 is again set on the magnetic disk 101. In this time, the aperture 157 is aligned with perpendicular to the direction of the alignment performed for forming the first easy axis 173. For example, it is preferable that the aperture 157 is aligned to the direction of 90 degree from the center of the polar coordinate system or the direction of 270 degree from the center. Rotate the magnetic disk 101 in constant velocity. An ion beam 161 including Ar⁺ is injected into the magnetic layer 115 through the aperture 157. Consequently, a second easy axis 175 of which direction is accordance to the radial direction of the polar coordinate is formed on the even numbered tracks 122b. On the other hands, there is no influence on the odd numbered tracks 122a covered by the photo-resist 119 so the first easy axis 173 is maintained thereon. Not shown in any figures, the method for controlling the scanning path and applying the external magnetic filed can be performed similar to the method of embodiment 1.

There is another method for set different easy axis on each track by using stencil mask only. First, as shown in FIG. 4a, a magnetic easy axis of which direction is parallel to the radial direction is formed on the magnetic layer 115 by setting stencil mask 151 having silt shaped aperture 157 on the magnetic disk 101. Then, the easy axis of which direction is parallel to the angular direction is formed on the whole tracks. This is the first easy axis 173 of this embodiment. And then, as shown in FIG. 7, the second stencil mask 251 having a second aperture 257 similar size of the track width is set on the magnetic disk 101. At this time, the second aperture 257 is designed for exposure the even numbered tracks 122b. It is preferable that the second aperture 257 is aligned to the direction of 90 degree from the center of the polar coordinate system or the direction of 270 degree from the center, because the second aperture 257 forms the second easy axis 175 parallel to the radial direction. The reason for doing so is that the direction of the easy axis form by the ion beam on the magnetic layer 115 is defined by the final situation of the ion beam implanting. In other words, when ion beam is implanted again as shown in FIG. 7, after the angular direction easy axis on the even numbered tracks 122b is formed previously as shown in FIG. 4a, then the second easy axis 175 of which direction is parallel to the radial direction is formed finally on the even numbered tracks 122b.

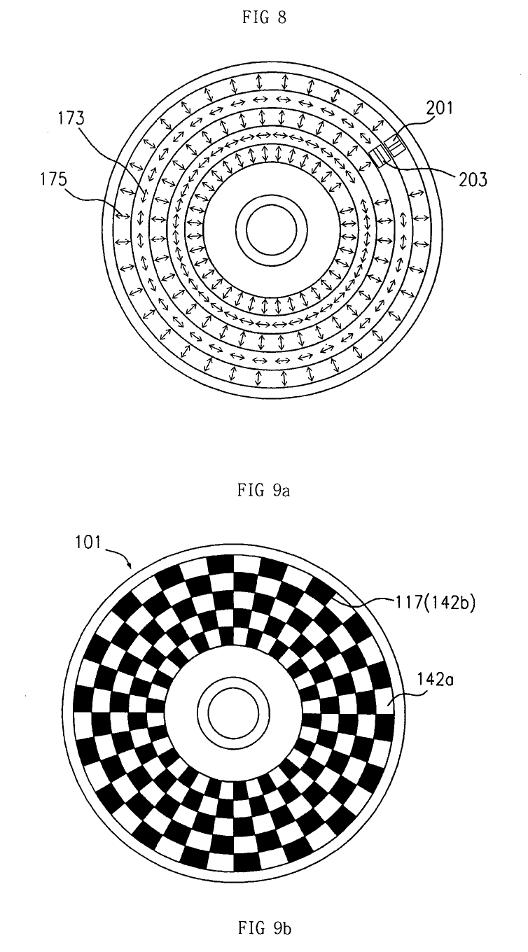

The magnetic storing device comprises a magnetic media and a magnetic head recording or retrieving data on the magnetic media. In order to use the magnetic media according to this embodiment, a new head system is needed. FIG. 8 is a plane view showing a new magnetic head system for the magnetic media of this embodiment. This head system comprises two heads. A first head 201 is used on the area having the first easy axis 173 and a second head 202 is used on the area having the second easy axis 175. The FIG. 8 shows the case of the first head 201 and the second head 202 are arrayed seriously. If one need, the first head 201 and the second head 202 are assembled in separated position. For example, the first head 201 and the second head 202 is positioned in diagonally faced each other to the center of magnetic disk 101. The first head 201 has the gap of poles in which the magnetic field can be formed along to the direction of the first easy axis 173 and the second head 202 has the gap of poles in which the magnetic field can be formed along to the direction of the second easy axis 175. When the first head 201 is positioned on the area has the second easy axis 175, the first head 201 does not react with the second easy axis. The reason is that the direction of the second easy axis 175 is perpendicular to the direction of the magnetic field formed by the first head 201 so, the magnetic force of the first head 201 is linearly independent with the magnetic force of the bit cell on the second easy axis 173.

The magnetic storing device according to this embodiment can be store information in the track gap area not used for recording area in the conventional method. Therefore, the recording density of this embodiment is greater 2 times than that of the preferred embodiment 1. Furthermore, the data transfer rate is faster 2 times than conventional technique because the individual two heads are used at the same time.

### PREFERRED EMBODIMENT 3

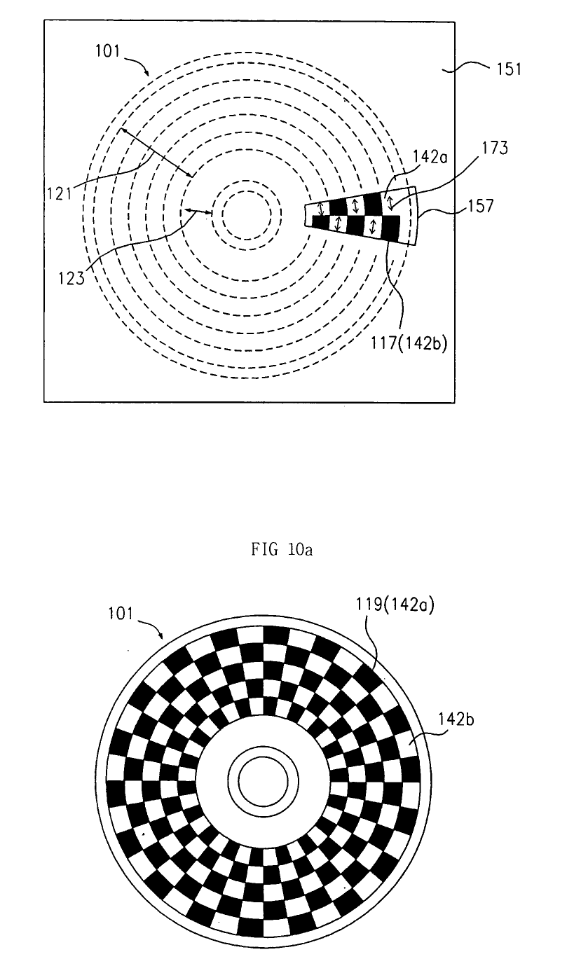

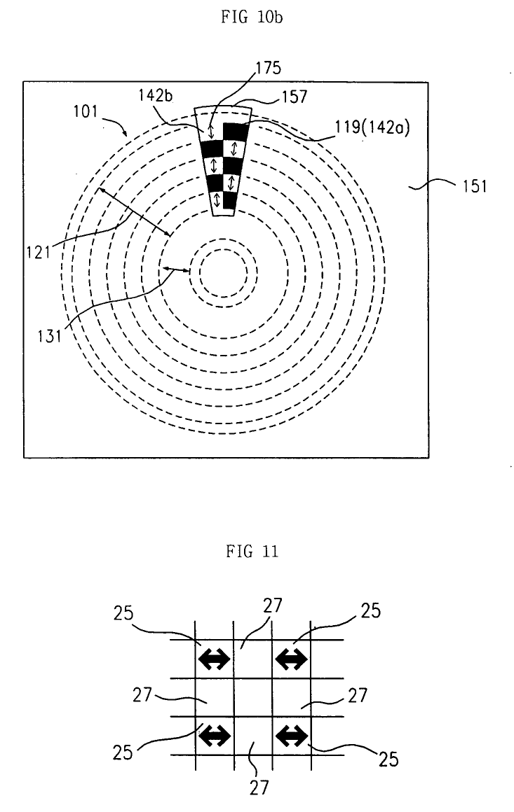

This embodiment explains about the case of applying the main concept of this invention to the bit level, the basic unit of recording information. The FIGS. 9a and 9b are plane views showing the method for forming a first easy axis on a first area using treatment of ion beam. The FIGS. 10a and 10b are plane views showing the method for forming a second easy axis on a second area.

Similarly to the embodiment 1 and 2, form a under layer 113 by depositing a non magnetic material such as Cr on a substrate 111 comprising glass or Al/Mg, and form a magnetic layer 115 by depositing a ferro-magnetic material such as CoPt, CoPtCr, CoPtCrTa, CoPtCrB, FePt or FrPtCr so that prepare a magnetic disk 101. The magnetic layer 115 comprises a data zone 121 in which data can be stored, and a parking zone 123 in which the head is kept when it is not operating. In the data zone 121, a series of rectangular shaped bits are arrayed accordance with the polar coordinate system. As shown in FIGS. 9a and 10a, the bits are divided into two groups, a first bit cell 142a and a second bit cell 142b. The first bit cell 142a and the second bit cell 142b have easy axes in which the direction of each axes has selected one direction between the two axes (radial and angular axes) comprising the polar coordinate system.

Deposit a photo-resist on the magnetic layer 115. Pattern the photo-resist, as shown in FIG. 9a, to remove the photo-resist on the first bit cell 142a and to cover the second bit cell 142b only by the remained photo-resist 117. Prepare a stencil mask 151 bigger than the magnetic disk 101. The stencil mask 151 has an aperture 157. The aperture 157 has a slit shape in which the width is similar to the length of the bit and the length is similar to the radius of the data zone 121.

The magnetic disk 101 is set in the vacuum chamber in the capable of rotation to the center of disk. The stencil mask 151 is set above the magnetic disk 101 with some distance between them. It is preferable that the aperture 157 is aligned to the direction of zero degree from the center of the magnetic disk 101 or the direction of 180 degree from the center. Rotate the magnetic disk 101 with constant velocity. At the same time, an ion beam 161 including Ar⁺ ion is implanted into the magnetic layer 115 through the aperture 157. Then, the ion beam 161 is implanted into the first bit cell 142a only, so that the first easy axis 173 parallel to the angular direction of the polar coordinate system is formed thereon. The ion beam does not influence the second bit cells 142b because they are covered by the photo-resist 117.

After remove the photo-resist 117, a new photo-resist is deposited on the magnetic layer 115 again. As shown in FIG. 10a, pattern the photo-resist to remove the photo-resist on the second bit cell 142b and to cover the first bit cell 142a only by the remained photo-resist 119. The stencil mask 151 is set above the magnetic disk 101 again. At this time, the aperture 157 is aligned to the direction of 90 degree from the center of the magnetic disk 101 or the direction of 270 degree from the center. Rotate the magnetic disk 101 with constant velocity. At the same time, an ion beam 161 including Ar⁺ ion is implanted into the second bit cell 142b the exposed area of the magnetic disk 101 through the aperture 157. Then, the second easy axis 175 parallel to the radial direction of the polar coordinate system is formed on the second bit cells 142b. On the other hands, the ion beam does not influence the first bit cells 142a because they are covered by the photo-resist 119, so that they have the first easy axis 173.

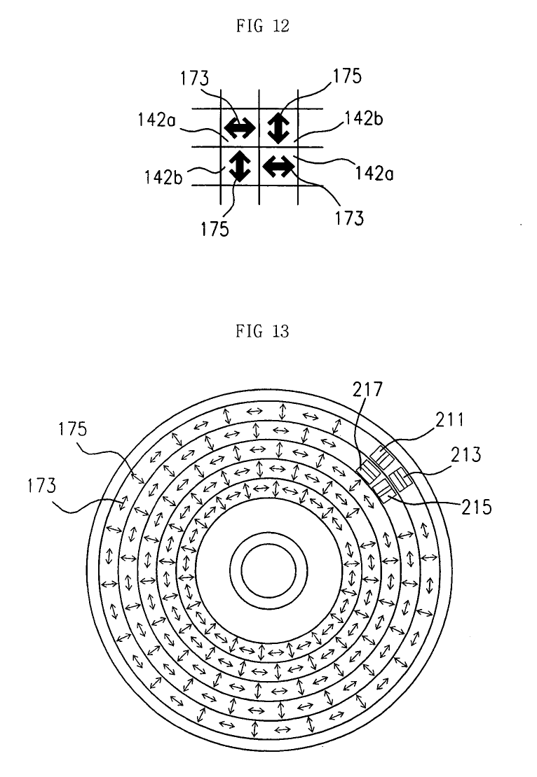

According to this embodiment, the bit cells are designed to have precisely defined boundary. Therefore, it is possible that the S/N ratio is much more enhanced than magnetic media manufactured by conventional technologies. The easy axes between the neighboring bit cells have different directions in which cross angle is about 90 degree, so that the exchange coupling and electromagnetic exchange force are minimized or eliminated. Therefore, it is possible to remove any vacancy area between bit cells, which has to be in the conventional technologies. For example, in the patterned media, there must be the vacancy area 27 comprising non-magnetic material between bit cells 25, as shown in FIG. 11. The FIG. 12 shows the array of the bit cells according to this embodiment. There is any vacancy area between the first bit cell 142a and the second bit cell 142b of the magnetic layer according to this embodiment. The each bit cells 142a or 142b has magnetic easy axis 173 or 175, furthermore, the neighboring bit cells 142a and 142b have different easy axis in which the angle between the directions is about 90 degree. By comparing the FIGS. 11 and 12, the recording density of this embodiment can be increased up to 4 times than conventional patterned media.

The magnetic storing device comprises a magnetic media and a magnetic head recording or retrieving data on the magnetic media. The FIG. 13 is a plane view showing one example of head system, which can record and retrieve data on the magnetic media manufactured by this embodiment. The suitable head system comprises 4 heads. The first head 211 is used for the bit cell having the first easy axis 173 and, the third head 215 is used for the bit cell having the first easy axis 173 on the neighboring track. The second head 213 is used for the bit cell having the second easy axis 175 and, the fourth head 217 is used for the bit cell having the second easy axis 173 on the neighboring track. The array of these four heads 211, 213, 215 and 217 can be designed by 4×4 matrix structure. In other words, if needs, the four heads are designed in separated positioning. It is preferable that the magnetic field direction between pole gap of the first head 211 and the third head 215 are aligned to the direction of the first easy axis 173. And, It is preferable that the magnetic field direction between pole gap of the second head 213 and the fourth head 217 are aligned to the direction of the second easy axis 175. Even if the first head 211 and the third head 215 are positioned on the bit cell having the second easy axis 175, they do not act. The reason is that the direction of the second easy axis 175 is perpendicular to the direction of the magnetic field formed by the first head 211 and the third head 215 so, the magnetic forces between the heads and the easy axis is linearly independent.

For another example for the head system, total new structure can be designed. It is preferable that there are crossed two heads with ‘+’ shape in which the two pole gaps of the two heads are crossed. In this case, while the first head is working, the second head should be off, and vice versa so that the different working signals are applied. For example, the signal for working the first head and the signal for working the second head should have π(=180 degree) phase difference.

In the case of this embodiment, the magnetic storing device treats the data using nibble (four bits) unit not bit unit used in conventional technique, because the four heads are working simultaneously. In other words, it is possible to record or to retrieve data with 4 bits at the same area in which only one bit is used for data treatment. Therefore, the data transfer is faster 4 times than conventional technique with the same disk rotation speed. Physically, the recording density is bigger 4 times than conventional technique. Furthermore, in the conventional technique where the one bit is the basic unit for information, the distinguished data is 2 kinds. On the contrary, the number of distinguished data is 16 in this embodiment where the 4 bits are the basic unit for information. Therefore, logically, the recording density is bigger 8 times than conventional technologies.

### Industrial Applicability

The present invention relates to the magnetic storing device. Especially, the present invention relates to the magnetic storing system including magnetic media and magnetic head system using for the magnetic media. The present invention suggests the method for controlling the magnetic properties of the magnetic layer by ion beam treatment. By performing the ion treatment the main scope of this invention, the magnetic momentum can be increased, the coercivity can be controlled and the easy axis can be formed freely. Furthermore, it is possible to overcome the physical limitation of the magnetic material by being free from the grain structure of the conventional technique. Therefore, it is possible not only to develop the ultra-high density media but also to develop the magnetic storing device with terra bits/in², by applying this invention to the hard disk system. Also, it is possible to develop high capable removing storages by applying this invention to the floppy disk system or magneto optical disk system. It is also possible to develop high density magnetic RAM by applying to the magnetic layer of the MRAM, the next generation memory device. This invention has high comfortable advantage with the conventional technologies, so that the most conventional techniques for hard disk system are adapted into this invention easily. Therefore, it is very easy to apply this invention to the hard disk industries and markets, so it is economically very effective. Furthermore, using the main scope of this invention in which the magnetic properties can be controlled freely, it is possible to develop any new magnetic device for most of all field using the magnetic materials.

1. A magnetic storing device comprises a magnetic media having an easy axis along to a first direction.

2. The magnetic storing device according to the claim 1, wherein the first direction is parallel to selected one axis of a coordinate system defined the driving system of the magnetic storing device.

3. The magnetic storing device according to the claim 2, wherein the coordinate system is rectangular system and, the first direction is parallel to selected one of a horizontal axis and a vertical axis comprising the rectangular system.

4. The magnetic storing device according to the claim 2, wherein the coordinate system is polar coordinate system and, the first direction is parallel to selected one of a radial axis and an angular axis of the polar coordinate system.

5. The magnetic storing device according to the claim 1, further comprises a rectangular shaped magnetic head in which the width and length ratio is 1:1.

6. A magnetic storing device comprises:
a magnetic media including a first area having a first easy axis with a first direction and, a second area having a second easy axis with a second direction and;
a magnetic head including a first head which react with the first area of the magnetic media and, a second head which react with the second area of the magnetic media.

7. The magnetic storing device according to the claim 6, wherein the difference of the angles between the first direction and the second direction is about 90 degree.

8. The magnetic storing device according to the claim 6, wherein the first easy axis is parallel to a first axis of a coordinate system defined the driving system of the magnetic storing device and;
the second easy axis is parallel to a second axis of the coordinate system.

9. The magnetic storing device according to the claim 8, wherein the coordinate system is a rectangular coordinate system;
the first direction is selected one of a horizontal axis and a vertical axis comprising the rectangular system and;
the second direction is parallel to the other axis.

10. The magnetic storing device according to the claim 8, wherein the coordinate system is a polar coordinate system;
the first direction is parallel to selected one of a radial axis and an angular axis of the polar coordinate system and;
the second direction is parallel to the other axis.

11. A method for manufacturing a magnetic storing device comprises steps of:
forming a magnetic media by depositing a magnetic material on a substrate;
setting a mask having an aperture above the magnetic media and;
forming a first easy axis on a first area of the magnetic media by ion beam treatment through the aperture.

12. The method for manufacturing a magnetic storing device according to the claim 11, further comprises a step of applying an external magnetic field in order to set the first easy axis to along with selected one direction of a coordinate system defining the driving system of the magnetic storing device.

13. The method for manufacturing a magnetic storing device according to the claim 11, wherein the coordinate system is a rectangular coordinate system and;
further comprises a step of applying an external magnetic field in order to set the first easy axis to along with selected one of horizontal and vertical direction of the rectangular coordinate system.

14. The method for manufacturing a magnetic storing device according to the claim 11, wherein the coordinate system is a polar coordinate system and;
further comprises a step of applying an external magnetic field in order to set the first easy axis to along with selected one of radial and angular direction of the polar coordinate system.

15. A method for manufacturing a magnetic storing device comprises steps of:
forming a magnetic media by depositing a magnetic material on a substrate;
defining a first area and a second area on the magnetic media;
setting a mask having an aperture above the magnetic media in a first condition;
forming a first easy axis on the first area by ion beam implanting through the aperture;
setting the mask above the magnetic media in a second condition and;
forming a second easy axis on the second area by ion beam implanting through the aperture.

16. The method for manufacturing a magnetic storing device according to the claim 15, further comprises a step of applying an external magnetic field to have an about 90 degree between the first easy axis and the second easy axis.

17. A method for manufacturing a magnetic storing device comprises steps of:
forming a magnetic media using a disk type substrate;
defining a first area and a second area on the magnetic media;
setting a mask having a first aperture exposing the first area and a second aperture exposing the second area and;
forming a first easy axis on the first area and a second easy axis on the second area by ion beam implanting through the first and second apertures with rotating the magnetic media.

18. The method for manufacturing a magnetic storing device according to the claim 17, further comprises a step of applying an external magnetic field to have an about 90 degree between the first easy axis and the second easy axis.

19. A method for manufacturing a magnetic storing device in which driving system is polar coordinate system comprises steps of:
forming a magnetic media using a disk type substrate;
defining a first area and a second area on the magnetic media;
exposing the first area whereas the second area is covered;
setting a mask having a silt shaped aperture above the magnetic media in which the aperture is along to a first direction;
forming a first easy axis on the first area by ion beam implanting through the aperture;
exposing the second area whereas the first area is covered;
setting the mask above the magnetic media in which the aperture is along to a second direction and;
forming a second easy axis on the second area by ion beam implanting through the aperture.

20. The method for manufacturing a magnetic storing device according to the claim 19, further comprises a step of applying an external magnetic field to have an about 90 degree between the first easy axis and the second easy axis.
